(19) United States
(12) Patent Application Publication
(10) Pub. No.: US 2026/0128605 A1
(43) Pub. Date: May 7, 2026

(54) CHARGING GUN, AND CHARGING EQUIPMENT

(71) Applicants: Futaijing Precision Electronics (Yantai) Co., Ltd., Yantai (CN); HON HAI PRECISION INDUSTRY CO., LTD., New Taipei (TW)

(72) Inventor: HAO-CHUN HSU, New Taipei (TW)

(21) Appl. No.: 19/021,737

(22) Filed: Jan. 15, 2025

(30) Foreign Application Priority Data
Nov. 6, 2024 (CN) 202411577499.2

(51) Int. Cl. H02J 7/00; F21V 33/00

(52) U.S. Cl. CPC H02J 7/70; F21V 33/0004

(57) ABSTRACT

This application provides a charging gun and a charging equipment, the charging gun comprises a shell, a charging head, and a light-emitting assembly. The shell is provided with a mounting cavity, a connecting wire extending through the mounting cavity, one end of the connecting wire is electrically connected with a power supply device. The charging head is detachable connected to one end of the shell, the charging head is electrically connected to the other end of the connecting wire. The light-emitting assembly is connected to the charging head, the light-emitting assembly is received in the mounting cavity, the charging head is configured to guide lights emitted by the light-emitting assembly to an outside of the charging head.

### FIELD

The present disclosure relates to field of charging gun technology, and in particular to a charging gun and charging equipment.

### BACKGROUND

At present, charging guns are generally equipped with lighting structures to facilitate the charging guns used in low-light environments where users cannot quickly align the charging gun with charging base of a product to be charged. However, most of the existing charging guns directly install the lighting structures on the exterior of the charging guns, a design not only leads to an increase in a volume of the charging gun, but also affects aesthetics of the charging gun.

Thus, there is room for improvement within the art.

### BRIEF DESCRIPTION OF THE DRAWINGS

Many aspects of the disclosure can be better understood with reference to the following drawings. The members in the drawings are not necessarily drawn to scale, the emphasis instead being placed upon clearly illustrating the principles of the disclosure. Moreover, in the drawings, like reference numerals designate corresponding members throughout the several views.

FIG. 1 shows a structure diagram of an embodiment of a charging gun according to the present application.

FIG. 2 shows an explosion diagram of the charging gun shown in FIG. 1.

FIG. 3 shows a structure diagram of a wire base of the charging gun shown in FIG. 1.

FIG. 4 shows a cross-section diagram of the charging gun shown in FIG. 1.

FIG. 5 shows a structure diagram of an embodiment of a charging equipment according to the present application.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening members, and is not necessarily limited to physical connections. The connection may be such that the objects are permanently coupled or releasably coupled. The term “substantially” is defined to be essentially conforming to the particular dimension, shape, or other feature that the term modifies, such that the member need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

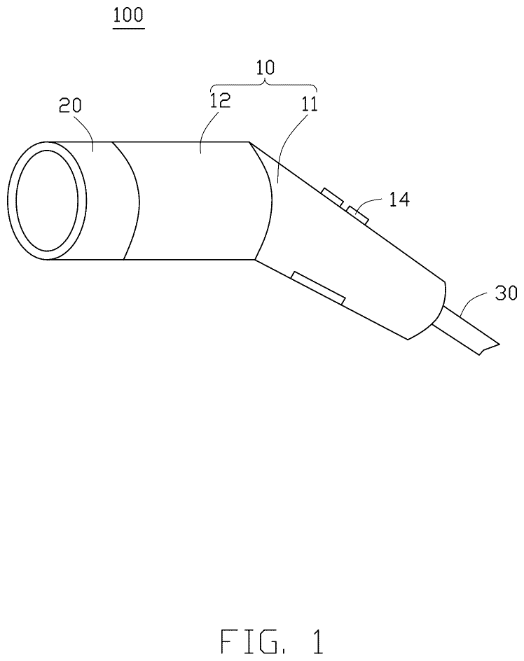

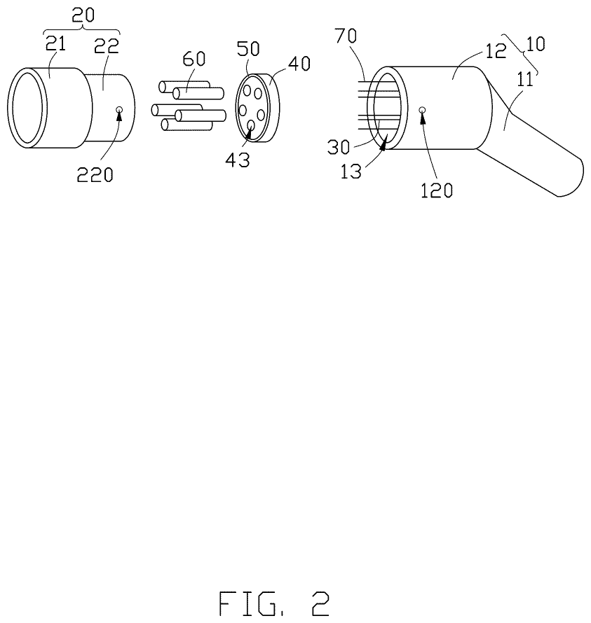

Referring to FIG. 1 to FIG. 2, in a first embodiment, the charging equipment 200 can be applied in various electronic fields such as entertainment and exercise. The charging equipment 200 includes an electronic body 10 and a charging gun 100a. The charging gun 100a is separate from the electronic body 10, and the charging gun 100a can be communicated with the electronic body 10 by wireless connection method or wire connection method. The charging gun 100a includes a control assembly 40, the control assembly 40 is in signal connection with the electronic body 10.

The charging gun 100a is applied as an executive structure of the charging equipment 200, users can operate the charging gun 100a to perform rotations and other actions by applying an external force to the charging gun 100a. The charging gun 100a can record its own rotation angle and other attitude changes, and then transfer the attitude changes to the control assembly 40. The control assembly 40 processes the attitude changes, and then generates one or more control signals, the control assembly 40 transmits one or more control signals to the electronic body 10, and the electronic body 10 executes one or more corresponding instructions of the control signals.

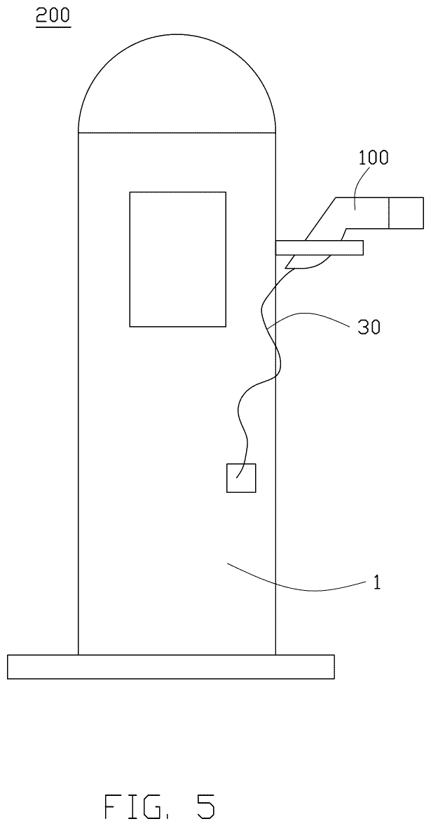

Referring to FIG. 1 to FIG. 2, and combined with FIG. 5, in the embodiment, the charging gun 100 is configured to charge charging products. The charging products can be electric vehicles, electric bicycles, electric tricycles and other products that need to be charged.

The charging gun 100 is used in conjunction with the power supply device 1. The power supply device 1 supplies power to the charging gun 100 by connecting wires 30. When the charging gun 100 is connected with the product to be charged, currents are transmitted to the product to be charged, and then the charging product is charged. The power supply device 1 can be a charging pile, etc.

The charging gun 100 includes a shell 10, a charging head 20, and a light-emitting assembly 50.

A mounting cavity 13 is provided in the shell 10, and a connecting wire 30 extends through the mounting cavity 13. The connecting wire 30 is a wire such as a cable that can achieve a current transmission. One end of the connecting wire 30 passes through the mounting cavity 13 and is electrically connected with the charging head 20. The other end of the connecting wire 30 is directly fixed with the power supply device 1 and electrically connected with the power supply device 1, thereby realizing a fixed design of the charging gun 100 and the power supply device 1.

In other embodiments, the connecting wire 30 is connected with the power supply device 1 through a plug structure, so as to realize a separate design of the charging gun 100 and the power supply device 1.

The charging head 20 is detachable connected to one end of the shell 10. The charging head 20 is configured for docking with the product to be charged, thus charging the charging product through the connecting wire 30 and the charging head 20. The light-emitting assembly 50 is connected to the charging head 20, and the light-emitting assembly 50 is received in the mounting cavity 13, which can hide the light-emitting assembly 50 in the shell 10 to avoid affecting appearances of the charging gun 100. The charging head 20 is configured to guide lights emitted by the light-emitting assembly 50 to outsides of the charging head 20, so that the light-emitting assembly 50 received in the mounting cavity 13 smoothly transmits the lights to the outsides of the shell 10, thus achieving a lighting function, so that users quickly connect the charging head 20 with the product to be charged.

Thus, in the embodiment, the charging head 20 is detachable connected with the shell 10, so that when the charging head 20 is damaged due to frequent plugging, the charging head 20 is capable of being quickly removed from the shell 10 for a maintenance or a replacement. In addition, compared with a way that the light-emitting assembly 50 is arranged outside the shell 10, the light-emitting assembly 50 is arranged in the shell 10, and the light-emitting assembly 50 is installed in an internal space of the shell 10, which can avoid an appearance change or a volume increase of the charging gun 100 caused by an addition of the light-emitting assembly 50. The light-emitting assembly 50 is installed on the charging head 20, to make the light-emitting assembly 50 is capable of being removed and discharged by removing the charging head 20.

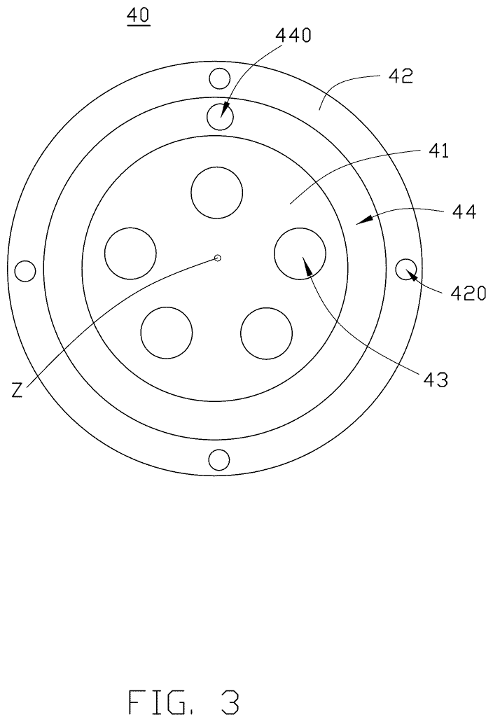

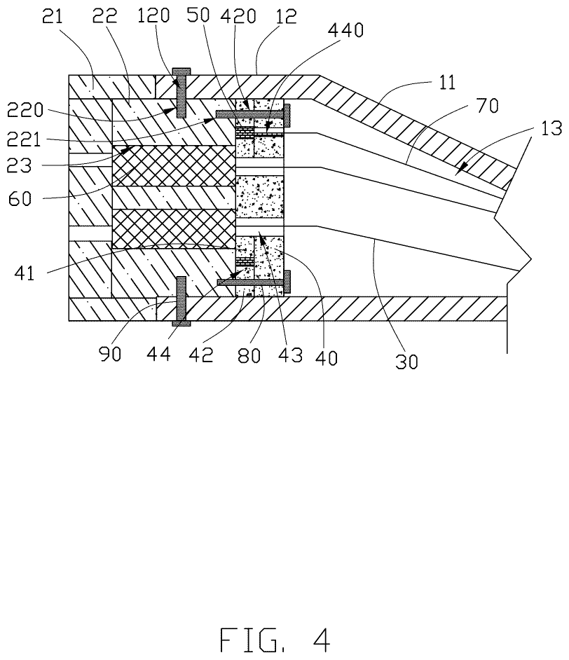

Referring to FIG. 2 to FIG. 4, in one embodiment, the shell 10 is a structure with internal hollow and open ends. The shell 10 includes a first shell 11 and a second shell 12. The connecting wire 30 extends from one end of the first shell 11 into the mounting cavity 13, and the second shell 12 is integrally formed with the other end of the first shell 11. The first shell 11 and the second shell 12 are tilted to facilitate the user to hold the first shell 11.

In one embodiment, a shape of the second shell 12 is cylindrical, and a first extension direction of the first shell 11 is set at an angle with a second extension direction of the second shell 12, the angle is greater than 90°.

In other embodiments, the second shell 12 can also be a columnar structure with rectangular or oval cross section.

In one embodiment, a key structure 14 is arranged on the first shell 11, and the key structure 14 is located on a peripheral surface of the first shell 11. A circuit board is provided in the mounting cavity 1, electronic components on the circuit board receive signal instructions of the key structure 14, and then control the charging gun 100 to perform a corresponding work (such as a start and a stop of the charging gun 100 or a selection of working states). A specific control mode of the key structure 14 of the charging gun 100 is designed by technicians in the field according to existing technologies.

In one embodiment, the charging head 20 is detachable connected to one end of the second shell 12 away from the first shell 11. The charging head 20 includes a first section 21 and a second section 22. The first section 21 and the second section 22 are arranged coaxially, and extension directions of the first section 21 and the second section 22 are parallel to an extension direction of the second shell 12. The second section 22 is integrally formed with a surface of the first section 21 near the second shell 12.

The second section 22 is received in the mounting cavity 13, and the second section 22 is detachable connected with the shell 10. When the second section 22 is received in the mounting cavity 13, a peripheral surface of the second section 22 abuts against an inner peripheral surface of the second shell 12, and an end surface of the first section 21 near the second section 22 abuts against an end surface of the second shell 12 away from the first shell 11, so as to realize a limit of the second shell 12 to the charging head 20. In addition, the second section 22 is sealed connected with the second shell 12 to ensure a tightness of a connection between the second section 22 and the second shell 12, to ensure that the light-emitting assembly 50 received in the shell 10 is in a sealed environment, to prevent liquids outside the shell 10 or charging head 20 from entering the mounting cavity 13 and affecting works of the light-emitting assembly 50, and to improve a waterproof ability of the charging gun 100.

A shape of the first section 21 matches a shape of the second shell 12, to ensure an aesthetic appearance of the charging gun 100. A sealing structure such as a sealing ring is arranged between an outer surface of the second section 22 and an inner surface of the second shell 12 to avoid rainwater from entering the mounting cavity 13.

In one embodiment, a second section 22 is provided with third connection holes 220, the third connection holes 220 are located on a peripheral surface of the second section 22. A number of the third connecting holes 220 is multiple, and the multiple third connecting holes 220 are distributed around an axis of the second section 22 at equal spacing, to improve a stability of the second section 22 when connecting with the shell 10. A number of the third connecting holes 220 can be two, three, four, etc.

The second shell 12 is provided with fourth connecting holes 120, the fourth connecting holes 120 are located on a peripheral surface of the second shell 12. A number of the fourth connection holes 120 is the same as the number of the third connection holes 220, and multiple fourth connection holes 120 are correspond to multiple third connection holes 220.

The charging gun 100 further includes second fasteners 90, a number of the second fasteners 90 is the same as the number of the third connection holes 220. Each second fastener 90 is threaded through a third connection hole 220 and a corresponding fourth connection hole 120, thereby securing the second section 22 to the second shell 12. The second fasteners 90 can be countersunk screws and other components.

In other embodiments, the second section 22 and the second shell 12 can also be fixed by clamping or gluing.

Referring to FIG. 2 to FIG. 4, in one embodiment, the charging gun 100 further includes a wire base 40, the wire base 40 is passed through by a connecting wire 30 to guide a layout of the connecting wire 30 and avoid a staggered winding of the connecting wire 30.

The wire base 40 is detachable connected to one end of the charging head 20 near the shell 10. The wire base 40 is defined a mounting slot 44, the mounting slot 44 faces towards the charging head 20. The light-emitting assembly 50 is received in the mounting slot 44, and the light-emitting assembly 50 is arranged towards the charging head 20. Thus, the light-emitting assembly 50 is installed on the wire base 40, and the wire base 40 is detachable connected with the charging head 20, so that when the light-emitting assembly 50 needs to be disassembled, the charging head 20 is removed from the shell 10, and the light-emitting assembly 50 is removed after the wire base 40 removed from the charging head 20. In addition, the light-emitting assembly 50, the wire base 40, the charging head 20 are independently set, when any one of the light-emitting assembly 50, the wire base 40, the charging head 20 is damaged, it is capable of replacing separately damaged components.

In one embodiment, the wire base 40 is provided with a first convex part 41 and a second convex part 42. The first convex part 41 and the second convex part 42 are arranged on one side of the wire base 40 near the charging head 20. A shape of the first convex part 41 is circular, the first convex part 41 is arranged around an axis Z of the wire base 40. The second convex part 42 is arranged around a peripheral surface of the first convex part 41, and the second convex part 42 and the first convex part 41 are spaced from each other to define the mounting slot 44 therebetween.

The light-emitting assembly 50 is fixed in the mounting slot 44 by clamping or gluing, and the wire base 40 is directly used as a mounting structure of the light-emitting assembly 50 to install the light-emitting assembly 50, without adding other mounting structures to install the light-emitting assembly 50. In addition, the light-emitting assembly 50 is directly installed on the wire base 40, which can avoid an installation of the light-emitting assembly 50 on the charging head 20 or the shell 10, resulting in a need to increase installation structures of the charging head 20 or the shell 10 to install the light-emitting assembly 50, affecting structures of the charging head 20 and the shell 10. Resulting in a need for additional mold opening to manufacture the charging head 20 or the shell 10 adapted to the light-emitting assembly 50, increasing a production cost.

In one embodiment, a luminous surface of the light-emitting assembly 50, an end surface of the first convex part 41 away from the wire base 40, and an end surface of the first convex part 41 away from the wire base 40 are coplanar, so that the light-emitting assembly 50 is capable of beaming more lights to the charging head 20.

In one embodiment, the light-emitting assembly 50 can be light-emitting elements such as LED lamp strips or LED lamp beads, the LED lamp strips or the LED lamp beads emit lights towards the charging head 20. The charging head 20 is made of translucent material, so that the lights emitted by the light-emitting assembly 50 can pass through the charging head 20 and shoot around the charging head 20 to achieve lighting. The charging head 20 is made of translucent material, which can scatter the lights emitted by the light-emitting assembly 50, so that the lights are softened and an effect of scattering lights is created.

In other embodiments, the charging head 20 can be made of transparent material, scattered particles are added to the charging head 20, so that the charging head 20 is set as a light source, users are capable of directly and clearly seeing a position of the charging head 20.

The scattered particles are materials with high scattering abilities. For example, the scattered particles are made of materials such as silica. When the charging head 20 is manufactured, the scattered particles are doped in a raw material of the charging head 20, so that the scattered particles are uniformly distributed throughout the charging head 20. The scattered particles are capable of dispersing the lights emitted into the charging head 20, and then expanding a lighting range of the light-emitting assembly 50, so that the charging head 20 can be used as a light source.

In one embodiment, the second convex part 42 is provided with a first connection hole 420, the charging head 20 is provided with a second connection hole 221, the second connection hole 221 is located at one end of the charging head 20 near the wire base 40. Extension directions of the first connection hole 420 and the second connection hole 221 are parallel to a direction of an axis of the charging head 20. The first connection hole 420 passes through the second convex part 42, the second connection hole 221 extends inwards from a surface of one side of the second section 22 away from the first section 21.

The charging gun 100 further includes a first fastener 80, the first fastener 80 is threaded through the first connection hole 420 and the second connection hole 221 for securing the wire base 40 and the charging head 20.

A number of the first connecting holes 420 is plurality, and the plurality of the first connecting holes 420 are arranged at equal spacing around the axis Z of the wire base 40. A number of the second connecting holes 221 is the same as a number of the first connecting holes 420, and the second connecting holes 221 correspond to the first connecting holes 420. The number of the first connection holes 420 is two, three, etc., to improve a tightness of a connection between the wire base 40 and the charging head 20. The wire base 40 is pressed against a surface of one side of the second section 22 away from the first section 21, so that the first convex part 41 and the second convex part 42 are pressed against the surface of the side of the second section 22 away from the first section 21, to ensure the tightness of the mounting slot 44, to avoid water or water vapor into the mounting slot 44 to affect an use of the light-emitting assembly 50.

The wire base 40 can be made of a certain elastic material, such as rubber, so that when the wire base 40 is pressed against the charging head 20, the wire base 40 has a certain elastic deformation to seal a contact surface between the second convex part 42 and the second section 22, and further ensure a safety of an use of the light-emitting assembly 50. In addition, the wire base 40 has a certain flexibility, and the wire base 40 is easy to hold the light-emitting assembly 50 directly in the mounting slot 44, not only convenient to take and place the light-emitting assembly 50, but also to avoid an installation structure to install the light-emitting assembly 50.

Referring to FIG. 2 to FIG. 4, in one embodiment, the first convex part 41 is provided with a wire hole 43. The wire hole 43 extends from a surface of the first convex part 41 near the charging head 20 to through the first convex part 41 and the wire base 40. The wire hole 43 allows the connecting wire 30 to pass through, and the connecting wire 30 passes through the wire hole 43 and connects with the charging head 20 to form a current channel.

A number of the connecting wire 30 is multiple, the connecting wires 30 include a ground wire, a neutral wire, a live wire, a signal wire and other types of cables. A number of the wire holes 43 is multiple, and the number of the wire holes 43 is the same as a number of the connecting wires 30, so that different connecting wires 30 can pass through different wire holes 43, so as to avoid connecting wires 30 winding each other.

The charging gun 100 further includes a light emitting wire 70. One end of the light emitting wire 70 is electrically connected to the power supply device 1, and the other end of the light emitting wire 70 passes through the mounting cavity 13 and is electrically connected to the light-emitting assembly 50, so that the light-emitting assembly 50 is also powered by the power supply device 1, avoiding the charging gun 100 to provide a separate power supply to the light-emitting assembly 50. In addition, since the light-emitting assembly 50 is installed on the wire base 40, when the connecting wire 30 is pulled through the wire base 40, the light emitting wire 70 can be simultaneously pulled to the wire base 40 to be electrically connected with the light-emitting assembly 50, so that there is no need to design a wiring method of the light emitting wire 70, which can simplify a wiring installation of the light-emitting assembly 50.

The wire base 40 is provided with a threading hole 440. The threading hole 440 is located on one side of the wire base 40 away from the charging head 20. An extension direction of the threading hole 440 is parallel to a direction of the axis Z of the wire base 40. The threading hole 440 communicates with the mounting slot 44 to insert one end of the light emitting wire 70 through the threading hole 440 into the mounting slot 44. The threading hole 440 provided by the wire base 40 is capable of guiding a layout of the light emitting wire 70 to avoid entanglements between the light emitting wire 70 and the connecting wire 30.

Referring to FIG. 2 to FIG. 4, in one embodiment, the second section 22 is provided with a holding slot 23, the holding slot 23 is located on one side of the second section 22 away from the first section 21. An extension direction of the holding slot 23 is parallel to an extension direction of the wire hole 43, a number of the holding slot 23 is the same as a number of the wire hole 43.

The charging gun 100 further includes connecting terminals 60, a number of the connecting terminals 60 is the same as a number of the holding slot 23. Any one of the connecting terminals 60 is contained in corresponding holding slot 23. One end of any one of the connecting wires 30 passes through the wire hole 43 and extends into the holding slot 23 and is electrically connected to the connecting terminal 60. One end of any one of the connecting terminal 60 away from the connecting wire 30 is connected to a product to be charged to form a current channel, and then the current channel between the power supply device 1 and the product to be charged is constructed by the connecting wire 30 and the connecting terminal 60 of the charging gun 100.

Referring to FIG. 5, in one embodiment, the charging equipment 200 includes the power supply device 1 and the charging gun 100. The power supply device 1 is configured to supply power to the charging gun 100, the charging gun 100 is directly fixed with the power supply device 1 by the connecting wire 30. The charging gun 100 is plugged into the power supply device 1 by providing a plug on the connecting wire 30, so that the charging gun 100 is capable of being used with different power supply devices 1.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of members within the principles of the present embodiments to the full extent indicated by the plain meaning of the terms in which the appended claims are expressed.

What is claimed is:

1. A charging gun comprising:
a shell provided with a mounting cavity, a connecting wire extending through the mounting cavity, one end of the connecting wire configured to be electrically connected with a power supply device;
a charging head detachable connected to one end of the shell, and electrically connected to another end of the connecting wire;
a light-emitting assembly connected to the charging head and received in the mounting cavity, the charging head configured to guide lights emitted by the light-emitting assembly to an exterior of the charging head.

2. The charging gun as claimed in claim 1, further comprising a wire base arranged in the mounting cavity and located at one end of the charging head close to the shell, wherein a mounting slot is defined on the wire base, the mounting slot faces towards the charging head, the light-emitting assembly is received in the mounting slot, and the light-emitting assembly faces towards the charging head.

3. The charging gun as claimed in claim 2, wherein the wire base is detachable connected to the shell or detachable connected to the charging head.

4. The charging gun as claimed in claim 2, wherein, the charging head and the shell cooperatively seal the mounting cavity.

5. The charging gun as claimed in claim 2, wherein the wire base is provided with a first convex part and a second convex part, each of the first convex part and the second convex part is located on a side of the wire base near the charging head, the first convex part is arranged around an axis of the wire base, the second convex part is arranged around a peripheral surface of the first convex part, the second convex part and the first convex part are spaced from each other, the mounting slot is formed between the first and the second convex parts.

6. The charging gun as claimed in claim 5, wherein the second convex part is provided with a first connection hole, the charging head is provided with a second connection hole at one end of the charging head near the wire base, the charging gun further comprises a first fastener, the wire base is fixed to the charging head by threading the first fastener through the first connection hole and the second connection hole.

7. The charging gun as claimed in claim 5, wherein, the first convex part is provided with a wire hole, the connecting wire extends through the wire hole.

8. The charging gun as claimed in claim 7, further comprising a light emitting wire, wherein one end of the light emitting wire is electrically connected with the power supply device, and another end of the light emitting wire is arranged through the mounting cavity and electrically connected with the light-emitting assembly.

9. The charging gun as claimed in claim 1, wherein the charging head is made of a translucent material.

10. The charging gun as claimed in claim 1, wherein the charging head is made of the transparent material and is provided with scattered particles.

11. A charging equipment comprising:
a power supply device,
a charging gun comprising a shell, a charging head, and a light-emitting assembly;
the shell comprising a mounting cavity, a connecting wire extending through the mounting cavity, one end of the connecting wire configured to be electrically connected with a power supply device;
the charging head detachable connected to one end of the shell, and electrically connected to another end of the connecting wire; and
a light-emitting assembly connected to the charging head and received in the mounting cavity, the charging head configured to guide lights emitted by the light-emitting assembly to an exterior of the charging head;
the power supply device is configured to supply power to the charging gun.

12. The charging equipment as claimed in claim 11, wherein the charging gun further comprises a wire base arranged in the mounting cavity and located at one end of the charging head close to the shell, wherein a mounting slot is defined on the wire base, the mounting slot faces towards the charging head, the light-emitting assembly is received in the mounting slot, and the light-emitting assembly faces towards the charging head.

13. The charging equipment as claimed in claim 12, wherein the wire base is detachable connected to the shell or detachable connected to the charging head.

14. The charging equipment as claimed in claim 12, wherein, the charging head and the shell cooperatively seal the mounting cavity.

15. The charging equipment as claimed in claim 12, wherein the wire base is provided with a first convex part and a second convex part, each of the first convex part and the second convex part is located on a side of the wire base near the charging head, the first convex part is arranged around an axis of the wire base, the second convex part is arranged around a peripheral surface of the first convex part, the second convex part and the first convex part are spaced from each other, the mounting slot is formed tween the first and the second convex parts.

16. The charging equipment as claimed in claim 15, wherein the second convex part is provided with a first connection hole, the charging head is provided with a second connection hole at one end of the charging head near the wire base, the charging gun further comprises a first fastener, the wire base is fixed to the charging head by threading the first fastener through the first connection hole and the second connection hole.

17. The charging equipment as claimed in claim 15, wherein, the first convex part is provided with a wire hole, the connecting wire extends through the wire hole.

18. The charging equipment as claimed in claim 17, wherein, the charging gun further comprises a light emitting wire, one end of the light emitting wire is electrically connected with the power supply device, and another end of the light emitting wire is arranged through the mounting cavity and electrically connected with the light-emitting assembly.

19. The charging equipment as claimed in claim 11, wherein, the charging head is made of a translucent material.

20. The charging equipment as claimed in claim 11, wherein the charging head is made of the transparent material and is provided with scattered particles.
